(19) United States
(12) Patent Application Publication
(10) Pub. No.: US 2011/0118156 A1
(43) Pub. Date: May 19, 2011

(54) LUBRICANT ADDITIVES FOR IMPROVING THE TRIBOLOGICAL PROPERTIES, NOVEL LUBRICANTS, PROCESS FOR THE PREPARATION THEREOF AND THE USE THEREOF

(75) Inventors: Thomas Rühle, Mannheim (DE); Michael König, Mannheim (DE); Thomas Rossrucker, Ostringen (DE); Detlef Pazdzior, Waghausel-Kirrlach (DE); Georg Hering, Bruhl (DE); David Larem, Eppertshausen (DE)

(73) Assignee: RHEIN CHEMIE RHEINAU GMBH, Mannheim (DE)

(21) Appl. No.: 12/898,819

(22) Filed: Oct. 6, 2010

(30) Foreign Application Priority Data
Oct. 9, 2009 (EP) 09172634.9

(51) Int. Cl. C10M 125/26; B82Y 30/00

(52) U.S. Cl. 508/136; 977/773

(57) ABSTRACT

The present invention relates to novel lubricant additives for improving the tribological properties, novel lubricants containing these additives, processes for the preparation thereof and the use thereof.

The present invention relates to novel lubricant additives for improving the tribological properties, novel lubricants containing these additives, a process for the preparation thereof and the use thereof.

Lubricants are native oils, such as castor oil or rapeseed oil, mineral oils, such as, for example, naphthenic mineral oils, and/or synthetic oils, such as, for example, poly-alpha-olefins or ester oils. These serve for reducing friction, which causes noise and in particular material wear. Moreover, the use of lubricants also permits heat removal.

Depending on the intended use, the lubricants are treated with a very wide variety of additives.

In addition to corrosion protection, the thermal stability, the viscosity index and the pour point, the tribological properties are also of decisive importance in the case of lubricants. These include primarily the reduction of friction and of wear, an improvement in the lubricating effect, including a heat-removing function, and the load-bearing capability. The load-bearing capability is a measure of the ability to prevent the welding of materials.

Synthetic lubricant additives used for preventing wear are zinc dithiophosphate (ZnDTP), zinc 4-methylpentyl-2-dithiophosphate or other anti-wear-additives, like alkylphosphates or amine phosphates or ashless dithiophosphates. Their tribological effect is produced by intensive chemical reaction with metals on the sliding surface. This results in the formation of reaction layers which protect the surface from wear and welding under extreme pressure. A disadvantage of these lubricant compositions is that they can be effective only at temperatures higher than room temperature. Furthermore, the lubricant compositions which are known from the prior art do not have sufficient high-temperature stability and, owing to the high decomposition rate, the “depot effect” is very rapidly used up at relatively high temperatures. In addition, these additives are not sufficiently active at temperatures which are too low, owing to the excessively low decomposition rates.

Furthermore, Teng, Jin-li et al in “Characterization and tribological properties of surface modified SiO₂ nanoparticles”, Gongcheng Xuebao (2006), 24(6), 874-876; disclose the use of surface-modified nanoparticles. This modification is expensive and complicated. Moreover, those particles are abrasive due to their sharp edges.

Tao, Xu et al., in Journal of Physics D: Applied Physics (1996), 29(11), 2932-2937, “The ball-bearing effect of diamond nanoparticles as an oil additive”, describe the ball bearing effect of nanoparticles. However, nanoparticles which are substantially smaller than 100 nm are too small to be able to effectively have this effect on customary steel surfaces, i.e. on polished and lapped steel surfaces; in actual fact, these particles disappear in the valleys of the “μ-mountains” of the steel surface. Thus, this effect must be seriously called into question and rather it must be assumed that these nanoparticles polish and hence smooth the surface and thus minimize the friction. A true and lasting effect (“anti-wear”) cannot be ensured here.

Starting from this prior art, it was the object of the present invention to provide novel lubricants for improving the tribological properties, which lubricants have a tribological mode of action over a large temperature range, in particular at low temperatures, and can be economically provided. It was intended to find a composition which shows an effect in particular for very low temperatures, as prevail, for example, during starting processes in the automobile, but also at high temperatures, where standard additives undergo complete thermal decomposition and are therefore ineffective.

In addition, it is preferable if the lubricant additives have pronounced mechanical and thermal stability and can therefore be used at high temperatures of preferably up to 1000° C., where conventional lubricant additives known to date usually fail.

Furthermore, the additives should preferably have a tribological effect in a purely mechanical manner and without chemical reactions.

Furthermore, there is a need for a lubricant having tribological properties which is chemically inert and does not react with other components which are usually present in additive packages for improving the lubricity. A disadvantageous effect on the performance of other additives is prevented thereby.

Furthermore, these alternatives should be at least equivalent to compositions of conventional lubricant additives based on zinc dithiophosphate and of ash-free lubricant additives with respect to performance and should fill gaps in effectiveness which are not covered by conventional AW additives and/or EP (extreme pressure) additives.

Finally, it is preferable if the lubricant additives have a relatively high thermal conductivity and can therefore very readily conduct heat from the lubricating gap in which they are used. In addition, the lubricants prepared therefrom should have an improved load-bearing capability.

This object is achieved by the novel lubricant additives which contain nanoparticles which are substantially spherical.

The lubricants are native oils, such as, for example, castor oil or rapeseed oil, mineral oils, such as, for example, naphthenic mineral oils, and/or synthetic oils, such as, for example, poly-alpha-olefin or ester oils. The term lubricant comprises all customary and commercially available lubricating oils.

These are, for example, soybean oil, palm oil, palm kernel oil, sunflower oil, maize germ oil, linseed oil, rapeseed oil, safflower oil, wheat germ oil, rice oil, coconut oil, almond oil, apricot kernel oil, avocado oil, jojoba oil, hazelnut oil, walnut oil, peanut oil, pistachio oil, triglycerides of medium-chain vegetable fatty acids (so-called MCT oils) and PUFA oils (PUFA=polyunsaturated fatty acids), such as eicosapentaenoic acid (EPA), docosahexaenoic acid (DHA) and α-linolenic acid; semisynthetic triglycerides, such as caprylic acid/capric acid triglycerides, such as the miglyol types; oleostearin, liquid paraffin, glyceryl stearate, isopropyl myristate, diisopropyl adipate, acetylstearyl 2-ethylhexanoate, liquid hydrogenated polyisobutenes, squalane, squalene; animal oils and fats, such as fish oils, such as mackerel, sprat, tuna fish, halibut, cod and salmon oil, lanolin, poppy seed oil, tung oil, tall oil, wood oil, resins and waxes, liquid terpenes and terpene oils, blown native oils obtained from native oils, complex esters, alkoxylated products, lard oil, tallow, sheep fat, vegetable and animal waxes, sperm oil, silicone oils and/or carnauba.

The present invention therefore relates to novel lubricants containing additives in the form of nanoparticles which are substantially spherical.

The lubricant additives according to the invention have a tribological effect at temperatures of 20 to 1000° C., preferably room temperature to 400° C., particularly preferably up to 250° C.

Nanoparticles in the context of the invention are preferably ceramic nanoparticles. Particularly preferably, these are selected from the group consisting of Al₂O₃, AlN, SiO₂, TiO₂, ZrO₂, Y₂O₃, WO₃, Ta₂O₅, V₂O₅, Nb₂O₅, CeO₂, boron carbide, aluminium titanate, BN, MoSi₂, SiC, Si₃N₄, TIC, TiN, ZrB₂, clay minerals (e.g. montmorillonite) and/or mixtures thereof and thermally stable carbonates and/or sulphates, such as, for example, zinc carbonate and/or zinc sulphate.

Substantially spherical in the context of the invention means that the particles represent an ellipsoid having three semiaxes a, b and c for which a≠b≠c or a=b=c. The ratios of the semiaxes are preferably a:b=1-100, a:c=1-1000, b:c=1:100 (cf. FIG. 1).

The spherical nanoparticles according to the invention preferably have a particle size of 1 to 5000 nm, preferably 10 to 500 nm, very particularly preferably from 50 to 300 nm, measured as primary particles.

In a preferred embodiment of the invention, the nanoparticles have no surface modification, for example by chemically bound siloxanes and/or silanes.

It is furthermore preferable if the nanoparticles have a thermal conductivity of 1 to 100 W/mK, more preferably of 20 to 80 W/mK, particularly preferably 40 to 60 W/mK.

In a further preferred embodiment of the invention, the nanoparticles have a thermal stability from room temperature to 1000° C., more preferably RT to 400, particularly preferably RT to 250.

The content of nanoparticles in the lubricant is preferably 0.05 to 95% by weight, more preferably 0.1 to 50% by weight, particularly preferably 0.5 to 5% by weight, based on the lubricant.

In a further embodiment of the invention, the nanoparticles are dispersed in a base fluid. In a further preferred embodiment of the invention, the base fluid may correspond to the subsequently intended lubricant (oils). However, it is also possible to use water for dispersing.

The base fluid is preferably selected from the group consisting of soybean oil, palm oil, palm kernel oil, sunflower oil, maize germ oil, linseed oil, rapeseed oil, safflower oil, wheat germ oil, rice oil, coconut oil, almond oil, apricot kernel oil, avocado oil, jojoba oil, hazelnut oil, walnut oil, peanut oil, pistachio oil, triglycerides of medium-chain vegetable fatty acids (so-called MCT oils) and PUFA oils (PUFA=polyunsaturated fatty acids), such as eicosapentaenoic acid (EPA), docosahexaenoic acid (DHA) and α-linolenic acid; semisynthetic triglycerides, such as caprylic acid/capric acid triglycerides, such as the miglyol types; oleostearin, liquid paraffin, glyceryl stearate, isopropyl myristate, diisopropyl adipate, acetylstearyl 2-ethylhexanoate, liquid hydrogenated polyisobutenes, squalane, squalene; animal oils and fats, such as fish oils, such as mackerel, sprat, tuna fish, halibut, cod and salmon oil, lanolin, poppy seed oil, tung oil, tall oil, wood oil, resins and waxes, liquid terpenes and terpene oils, blown native oils obtained from native oils, complex esters, alkoxylated products, lard oil, tallow, sheep fat, vegetable and animal waxes, sperm oil, silicone oils, carnauba and/or water.

It has furthermore proved advantageous that the nanoparticles are chemically inert, not microbiologically degradable and not oxidizable.

In addition to the additives according to the invention, further constituents selected from the group consisting of viscosity index improvers, detergents, dispersants, antifoams, EP additives, pour point depressants, corrosion protection additives, nonferrous metal inhibitors, friction modifiers, lubricity improvers, antioxidants, tackiness agents, demulsifiers, emulsifiers, deaerators, wetting agents, water in the form of emulsions, solid lubricants, thickeners, such as soap thickeners; polyureas, bentonites, polymorphic silicas, solubilizers, flameproofing agents, thixotropic agents, dilation agents, antiwear (AW) additives, dyes, pigments, tracers and/or fragrances can additionally be used in the lubricant.

The content of further constituents in the lubricant is preferably 0.001 to 50.00% by weight, more preferably 0.50 to 20% by weight, particularly preferably 1.00 to 5.00% by weight, based in each case on the lubricant.

The present invention also relates to a process for the preparation of the lubricants, characterized by the following process steps:

(a) mixing the substantially spherical nanoparticles in a base fluid with optionally further additives; and
(b) dispersing by mechanical action on the mixture resulting from process step (a) and optionally
(c) adding (metering) in further additives.

It is preferable if the mechanical action mentioned above under (b) is carried out by means of rolls, Ultraturrax, ultrasound, spray drying, electrostatic methods, pH change, use of dispersants, stirrers and mills, in particular ball mills, for (wet) milling.

These are commercially available devices and commercially available starting materials.

### BRIEF DESCRIPTION OF THE DRAWING

FIG. 1 schematically illustrates the ratios of the nanoparticles of lubricant additives being substantially spherical such that the particles represent an ellipsoid having three semiaxes a, b and c for which a≠b≠c or a=b=c.

The present invention furthermore relates to the lubricant additives obtainable by this abovementioned process.

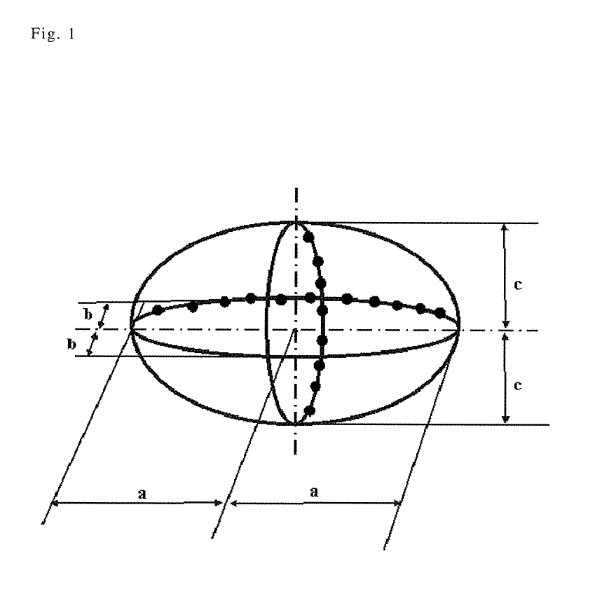

The invention furthermore relates to lubricants which contain nanoparticles which are substantially spherical. The definitions and embodiments mentioned further above and FIG. 1 are applicable to the nanoparticles.

In a further embodiment of the invention, the lubricants additionally contain further constituents selected from the group consisting of viscosity index improvers, detergents, dispersants, antifoams, EP additives, pour point depressants, corrosion protection additives, nonferrous metal inhibitors, friction modifiers, lubricity improvers, antioxidants, tackiness agents, demulsifiers, emulsifiers, deaerators, wetting agents, water in the form of emulsions, solid lubricants, thickeners, such as soap thickeners; polyureas, bentonites, polymorphic silicas, solubilizers, flameproofing agents, thixotropic agents, dilation agents, antiwear additives, dyes, pigments, tracers and/or fragrances.

It is preferable if the content of further constituents is 0.001 to 50.00% by weight, more preferably 0.50 to 20% by weight, particularly preferably 1.00 to 5.00% by weight, based in each case on the lubricant.

The invention also relates to the use of the lubricant additives according to the invention for improving the tribological properties and for the load-bearing capability. This primarily comprises the reduction of the friction and of the wear, improvement of the lubricating effect, including a heat-removing function. The load-bearing capability is a measure of the ability to prevent welding of materials.

Owing to the additive according to the invention, the lubricants according to the invention can be widely used. Fields of use to be mentioned in particular are high-temperature applications in lubricating pastes, for example for pressing in sliding bearing bushes and roller bearing rings, for pressing on gearwheels and chain wheels, for lubricating guides, joints and threads and as a mounting aid; for use in engine oils and in gear oils, in fats and release agents and in heat transfer liquids and in hydraulic fluids (force-transmitting fluids) for flame retardance.

In addition, they can be used as metal-working fluids for reducing the high forces, which may occur in metal working and metal shaping, and as a cooling lubricant.

Furthermore, they can be used for FDA applications, i.e. food-safe applications, since it may be assumed for a major part of nanoparticles according to the invention that they are not harmful to health and hence may be used as ingredients for food.

Lubricants which contain the additives according to the invention can moreover obtain the ecological label since the additives are neither toxic to aquatic life nor toxic to warm-blooded animals.

The present invention is explained in more detail with reference to the following example, without having a limiting effect:

### Working Examples

90% of spherical SiO₂ nanoparticles having a particle diameter of 100 nm are stirred with 10% of pure DITA (diisotridecyl adipate) or 10% of pure rapeseed oil as base oils to give a paste. The nanoparticles are not yet isolated in this paste, which is evident from the fact that the paste is opaque. After the paste has been passed once through a roll mill with the narrowest nip, a transparent or at least translucent gel is obtained, which is clear evidence that the nanoparticles are completely dispersed.

These concentrates with pure DITA or rapeseed oil are then used to prepare a lubricating oil or lubricating grease therefrom.

As is evident from Table 1, 1% nanoparticle concentrations in the respective base oils are realized. The antiwear (AW) properties were tested against the lubricating oils to which additives had not been added, by means of test runs on the four-ball apparatus according to DIN 51350 and on a reciprocating friction tester (SRV tester). The results are shown below.

TABLE 1

| | VKA wear scar according to |
|---|---|
| Sample | DIN 51350-3 (1 h × 300N ) |
| Pure DITA | 0.92 mm |
| DITA with 1% of | 0.50 mm |
| nanoparticles | |
| Pure rapeseed oil | 0.75 mm |
| Rapeseed oil with 1% of | 0.45 mm |
| nanoparticles | |

In the case of the lubricants according to the invention, a clear AW effect is evident since the value for the spherical wear cap virtually halves.

TABLE 2
Reciprocating friction (SRV) step test in rapeseed oil

| Concentration of | | |
|---|---|---|
| the SiO₂ | Results [pass load/ | Results [pass load/ |
| nanoparticles in | failure load] at | failure load] at |
| rapeseed oil [%] | room temperature | 80° C. |
| 0 | 600/700N | 600/700N |
| 0.1 | 600/600N | 700/900N |
| 1 | 800/900N | 1100/1200N |
| 3 | 1200N | 1100/1200N |

In rapeseed oil (cf. Table 2), a significant effect is observable for the reciprocating friction (SRV) test since the SRV pass load (a measure of the load-bearing capability and wear of the oil) can be virtually doubled.

At higher temperatures (≧80° C.) even when some or all of the liquid is evaporated or decomposed the tribological properties of the spherical nanoparticles according to the invention are still observable.

What is claimed is:

1. Lubricants containing ceramic nanoparticles as additives, these being selected from the group consisting of Al₂O₃, AlN, SiO₂, TiO₂, ZrO₂, Y₂O₃, WO₃, Ta₂O₅, V₂O₅, Nb₂O₅, CeO₂, boron carbide, aluminium titanate, BN, MoSi₂, SiC, Si₃N₄, TiC, TiN, ZrB₂, clay minerals and/or mixtures thereof and thermally stable carbonates and/or sulphates, the nanoparticles representing an ellipsoid having three semiaxes a, b and c, for which a≠b≠c or a=b=c, and the ratios of the semiaxes being a:b=1-100, a:c=1-1000, b:c=1:100.

2. Lubricants according to claim 1, characterized in that the nanoparticles have a particle size of 1 to 5000 nm.

3. Lubricants according to claim 1, characterized in that the nanoparticles have a thermal conductivity of 1 to 100 W/mK.

4. Lubricants according to claim 1, characterized in that the nanoparticles are dispersed in a base fluid.

5. Lubricants according to claim 4, characterized in that the base fluid is water and/or at least one oil which is selected from the group consisting of soybean oil, palm oil, palm kernel oil, sunflower oil, maize germ oil, linseed oil, rapeseed oil, safflower oil, wheat germ oil, rice oil, coconut oil, almond oil, apricot kernel oil, avocado oil, jojoba oil, hazelnut oil, walnut oil, peanut oil, pistachio oil, triglycerides of medium-chain vegetable fatty acids and PUFA oils (PUFA=polyunsaturated fatty acids), eicosapentaenoic acid (EPA), docosahexaenoic acid (DHA) and α-linolenic acid; semisynthetic triglycerides, such as caprylic acid/capric acid triglycerides, miglyol types; oleostearin, liquid paraffin, glyceryl stearate, isopropyl myristate, diisopropyl adipate, acetylstearyl 2-ethylhexanoate, liquid hydrogenated polyisobutenes, squalane, squalene; animal oils and fats, such as fish oils, such as mackerel, sprat, tuna fish, halibut, cod and salmon oil, lanolin, poppy seed oil, tung oil, tall oil, wood oil, resins and waxes, liquid terpenes and terpene oils, blown native oils obtained from native oils, complex esters, alkoxylated products, lard oil, tallow, sheep fat, vegetable and animal waxes, sperm oil, silicone oils and/or carnauba.

6. Lubricants according to claim 1, characterized in that the content of nanoparticles is 0.05 to 95% by weight, based on the lubricant.

7. Process for the preparation of the lubricants according to claim 1, characterized by the following process steps:
(a) mixing the nanoparticles in a base fluid with optionally further additives; and
(b) dispersing by mechanical action on the mixture resulting from process step (a) and optionally
(c) adding in further additives,
(d) stirring into the lubricant.

8. Lubricants according to claim 1, characterized in that they contain native oils, mineral and/or synthetic oils or ester oils.

9. Lubricants according to claim 8, characterized in that they additionally contain further constituents selected from the group consisting of viscosity index improvers, detergents, dispersants, antifoams, EP additives, pour point depressants, corrosion protection additives, nonferrous metal inhibitors, friction modifiers, lubricity improvers, antioxidants, tackiness agents, demulsifiers, emulsifiers, deaerators, wetting agents, water in the form of emulsions, solid lubricants, thickeners, soap thickeners; polyureas, bentonites, polymorphic silicas, solubilizers, flameproofing agents, thixotropic agents, dilation agents, antiwear (AW) additives, dyes, pigments, tracers and/or fragrances.

10. Process for improving the tribological properties and load-bearing capability in high-temperature applications in lubricating pastes by using lubricants according to claim 1.
